(19) United States
(12) Patent Application Publication
(10) Pub. No.: US 2012/0185123 A1
(43) Pub. Date: Jul. 19, 2012

(54) SYSTEM AND METHOD FOR VEHICLE PATH DETERMINATION

(76) Inventors: Adil Ansari, Kennesaw, GA (US); Rahul Chillar, Atlanta, GA (US)

(21) Appl. No.: 13/009,047

(22) Filed: Jan. 19, 2011

(51) Int. Cl. G05D 1/00; G01C 21/00

(52) U.S. Cl. 701/25; 701/23

(57) ABSTRACT

A method for determining a path for the autonomous operation a vehicle with a task space is provided. The method comprises detecting multiple temperature sources located at the boundaries of the task space; recording the one or more positional coordinates associated with the temperature sources; storing the one or more positional coordinates; and retrieving the one or more positional coordinates and navigating the vehicle based on the one or more positional coordinates.

### FIELD

The embodiments described herein relate generally to autonomous vehicles, and more specifically to methods and systems for designing autonomous vehicles which carry out set functions within a set path.

### BACKGROUND

Systems and methods for implementing repetitive task processes are the subject of contact and effort with research and development initiatives. Tasks that lend themselves to automated operation generally include tasks that do not involve a great deal of human interaction when performed by a machine. In furtherance of such automated processes, automated devices have been designed and deployed which serve to operate within a defined task space or landscape.

### SUMMARY

In one embodiment, a method for determining a path for the autonomous operation a vehicle with a task space is provided. The method comprises detecting multiple temperature sources located at the boundaries of the task space; recording the one or more positional coordinates associated with the temperature sources; storing the one or more positional coordinates; and retrieving the one or more positional coordinates and navigating the vehicle based on the one or more positional coordinates.

In one embodiment, a method for operating a vehicle within a task space autonomously is provided. The method comprises operating the vehicle in a teaching mode in the task space and recording or more positional coordinates during the operation and detecting one or more temperature sources located at the boundaries of the task space and recording one or more positional coordinates associated with the location of the detected one or more temperature sources; and operating the vehicle in an autonomous mode by recalling the one or more positional coordinates recorded during the teach mode.

In one embodiment, a vehicle for autonomous operation within a task space is provided. The vehicle comprises a memory for storing one or more sets of positional coordinates, and a processor coupled to the memory for: (i) detecting multiple temperature sources located at the boundaries of the task space; (ii) recording the one or more positional coordinates associated with the temperature sources; (iii) storing the one or more positional coordinates; and (iv) retrieving the one or more positional coordinates and navigating the vehicle based on the one or more positional coordinates.

In other aspects, computer programming and other apparatus, systems and methods are provided to achieve the above and other aspects to the invention.

### BRIEF DESCRIPTION OF THE DRAWING FIGURES

For a better understanding of the present invention and to show more clearly how it may be carried into effect, reference will now be made, by way of example, to the accompanying drawings, which show a preferred embodiment of the present invention and in which:

FIG. 1 is a block diagram of the landmarks of a task space;

FIG. 2 is a block diagram of the components of the path tracing vehicle;

FIG. 3 is a block diagram of a path vehicle traversing a task space;

FIG. 4 is a flowchart illustrating the steps of a path vehicle operation method;

FIG. 5 is a flowchart illustrating the steps of a teaching method;

FIG. 6 is a flowchart illustrating the steps of an autonomous method;

### DETAILED DESCRIPTION OF THE PREFERRED EMBODIMENT

It will be appreciated that, numerous specific details have provided for a thorough understanding of the exemplary embodiments described herein. However, it will be understood by those of ordinary skill in the art that the embodiments described herein may be practiced without these specific details. In other instances, well-known methods, procedures and components have not been described in detail so as not to obscure the embodiments described herein. Furthermore, this description is not to be considered so that it may limit the scope of the embodiments described herein in any way, but rather as merely describing the implementation of the various embodiments described herein.

The embodiments of the apparatus, systems and methods described herein may be implemented in hardware or software, or a combination of both. Furthermore, the system, processes and methods of the described embodiments are capable of being distributed as computer programming in a computer program product comprising a computer readable medium that bears computer usable instructions for execution on one or more processors.

The description which follows, and the embodiments described therein, are provided for illustration by way of an example, or examples, of particular embodiments of the principles of the present invention. These principles are provided for purposes of explanation, and not limitation of those principles, and of the invention.

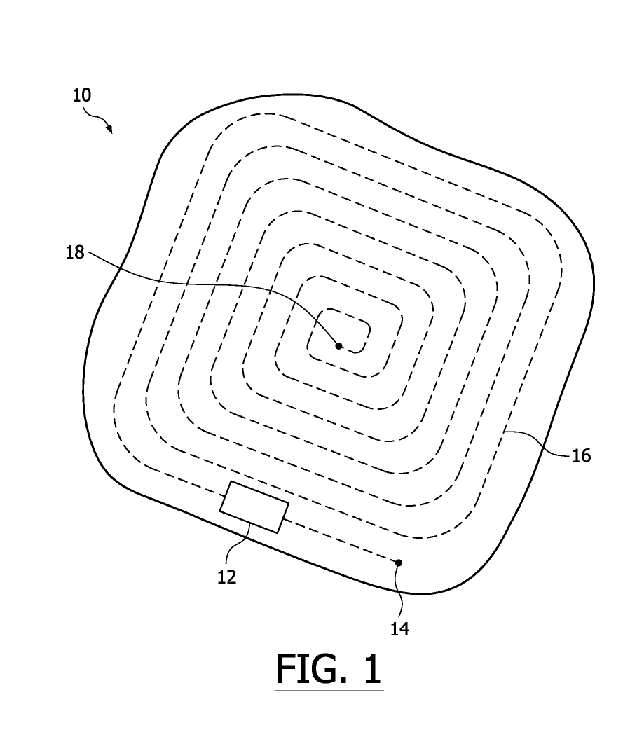

The embodiments described herein, as will be more fully understood with the accompanying description, relate to methods and systems for generating path tracing vehicles that can operate in an autonomous mode without the need for user controls. The term path tracing vehicle or path vehicle is used herein to refer to any vehicle that is used to perform repetitive functions, including but not limited to lawn mowers, vacuum cleaners, floor polishing machines, and snow blowers. The path tracing vehicle is described in further detail below with reference to the accompanying figures. As will be described herein, the path vehicle once configured or programmed for a specific path does not require user interaction to perform a repetitive task function in the same task space. Reference is now made to FIG. 1 where a block diagram illustrating the landmarks associated with a task space 10 is shown in an exemplary embodiment. A task space 10 refers to any space that a path vehicle 12 operates in. The tasks space 10 may be comprised of natural landmarks or removable obstacles, and the path vehicle 12 traverses the task space 10 in order to perform its tasks. Tasks or functions performed by the path vehicle may be any function that is required to be undertaken in the task space 10, including, but not limited to vacuuming, lawn mowing, snow plowing, and other such repetitive functions. As will be understood by one of skill in the art, the task space may be an indoor or outdoor space.

The path vehicle 12 that traverses a task space 10 begins the traversal process at a start location 14, and follows a path 16, until the end point is reached 18. The method by which the path 16 is determined and then subsequently followed is described in further detail below.

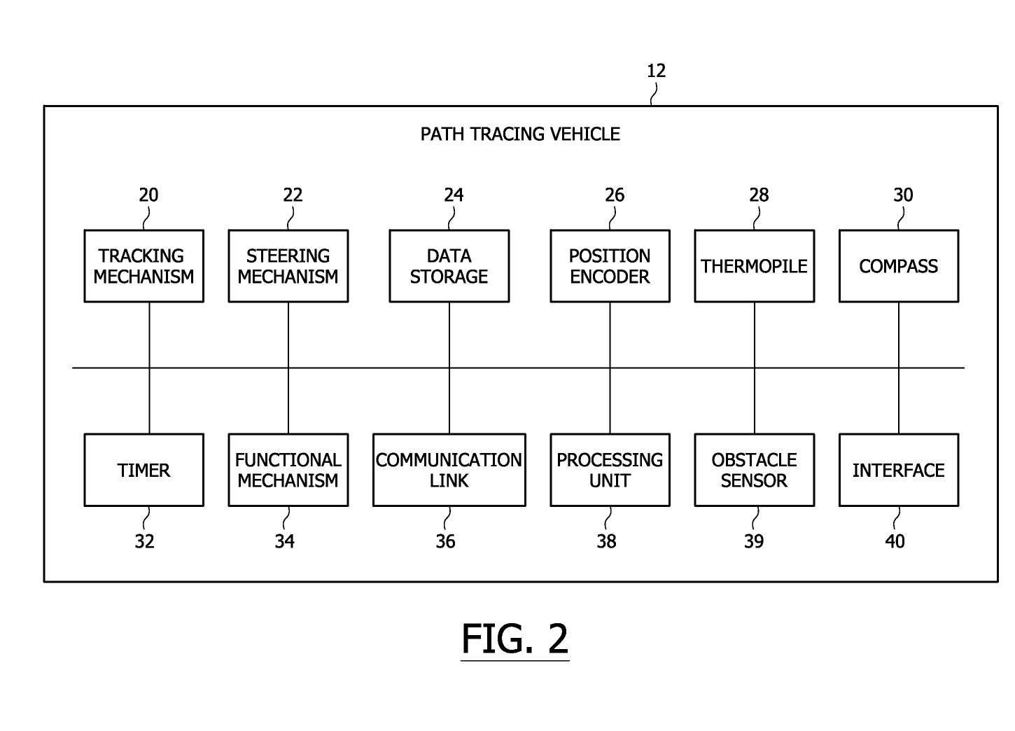

Reference is now made to FIG. 2, where the components of the path vehicle 12 are shown in an exemplary embodiment. The path tracing vehicle 12 has associated with it wheels or other tracking mechanism 20, a steering mechanism 22, a data storage 24, a position encoder 26, a thermopile 28, a compass 30, a timer 32, a functional mechanism 24, a communication link 36, a processing unit 38, a obstacle sensor 39 and an optional interface 40.

The wheels 20 are used to traverse the path 14. The steering mechanism 22 is used to maneuver the path vehicle through the task space by following the path 16. The data storage mechanism 24 is used to store the key co-ordinates and positional and timing data that allows the path vehicle 12 to navigate the path 16. The position encoder 26 is used to continuously track the wheel positions, through tracking of the wheel revolutions, and angle of travel The thermopiles are used to detect temperature sources which are then used in the navigation of the path in order to determine the boundaries associated with the task space as described below. In one embodiment, a Perkin Elmer thermopile, model number TPS334 is used. The compass 30 is used to orient the path vehicle 12 as positional and angular information is stored in memory. The timer 32 is used to record the timing, number of rotations of the wheels and other sensors at any given time. The function mechanisms 34 are used to implement the function that the path tracing vehicle 12 is used for, for example the function mechanisms may include a lawn mower assembly or a vacuum cleaner assembly. The communication link 36 allows for the path tracing vehicle 12 to have an interface with a communication device, and may include a wired or wireless connection. The communication link may be used to upload customized path traversal algorithms to the path tracing vehicle 12. The processing unit 38 is used to receive and process the information provided by the respective components of the path tracing vehicle 12. The sensor 39 is described in more detail below and is used to detect the presence of physical obstacles. The interface 40 allows for an optional method by which parameters associated with the path tracing vehicle 12 may be set.

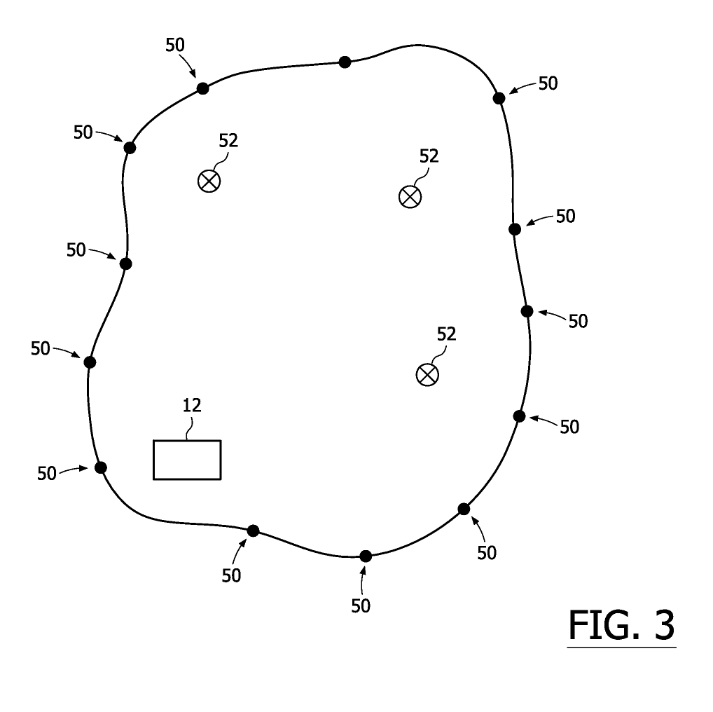

Reference is now made to FIG. 3 where a block diagram of a path tracing vehicle 12 traversing a task space with temperature sources 50. The temperature sources are used to demarcate the outer boundaries of the task space 10. The temperature sources 50 are placed at the outer boundaries of the task space 10 such that the thermopiles associated with the path tracing vehicle 12 are able to detect the temperature sources and determine that the edge of the task space have been reached. The diagram of FIG. 3 is also shown having an obstacle 52 present within the task space 10. It will be understood that a task space 10 may have one or more obstacles 52 associated with it. The obstacles 50 represent physical structures or objects that must be navigated around for purposes of traversing a path, and for completing the function associated with the path tracing vehicle 12. As will be described in further detail below, the path tracing vehicle will always have one temperature source 50 in its field of detection/view to ensure that the path vehicle 12 can appropriately carry out its function by being able to determine, without the need for any global positioning data, the outer extremities of the task space 10.

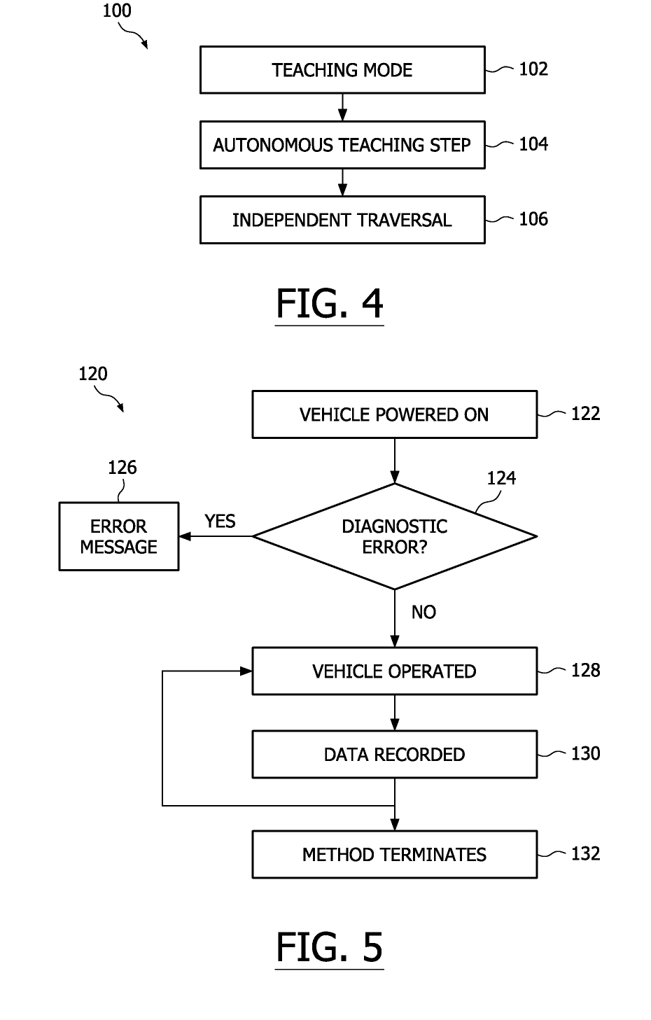

Reference is now made to FIG. 4, where a flowchart illustrating the steps of a tracing vehicle operation method 100 are shown in an exemplary embodiment. The steps of the operation method 100 are the general steps associated with the operation of the path vehicle 12 for both teaching and operation of the vehicle 12 and are described in further detail in the description that follows.

Method 100 begins at step 102 where the path tracing vehicle is operated in a teaching mode in the task space 10. The teaching mode is more fully described in FIG. 5, and is used to teach the path tracing vehicle the co-ordinate positions associated with the task space 10 that must be navigated by the path vehicle 12. The teaching mode of step 102 is undertaken by a user or operator of the path tracing vehicle guiding the path vehicle 10 through the task space 10 to ensure that all areas of the task space where a function must be performed are in fact covered. Upon the teaching mode of step 102 being completed, method 100 proceeds to step 104. At step 104, an autonomous teaching step is undertaken where the path tracing vehicle 12 navigates the task space autonomously without the help of a user or operator. The autonomous mode of operation undertaken at step 104 allows the path tracing vehicle to undertake an independent traversal of the task space. Method 100 then proceeds to step 106, where the path vehicle 12 is able to traverse the space 10 independently as based on steps 102 and 104 it has learned to operate within the task space 10 autonomously. Step 106 is undertaken as required where the vehicle 12 must perform its specific functions.

Reference is now made to FIG. 5, where a flowchart illustrating the steps in an exemplary embodiment of the teaching method shown in step 102 of method 100. The teaching method 120 is described in further detail herein. The teaching method 120 begins at step 122. The teaching method and the autonomous method described below both require that the temperature sources described above have been placed at the extremities of the task space 10. The teaching method 120 begins at step 122 where the vehicle is powered on and the vehicle is placed within the task space 10. In an exemplary embodiment, the path vehicle 12 is instructed to record the respective coordinates associated with the teaching mode through either engaging a button on the path vehicle, or through a remote instruction to the vehicle. As the path vehicle 12 has been instructed to record its co-ordinates, it will continue to do so during the path traversal until otherwise instructed. Method 120 then proceeds to step 124 where a diagnostic self test is performed by the path vehicle 12. The diagnostic self test ensures that the various components associated with the tracing vehicle as described in FIG. 2 are in operational order. Where the results of the diagnostic test performed at step 124 indicate that one or more components are not in an operational order, method 100 proceeds to step 126 where an error or fault message is displayed to the user or operator. If the result of the diagnostic self test performed at step 124 is a pass, method 100 then proceeds to step 128, where the vehicle is operated from a starting point in the task space 10 to an end point. During the operation of the path vehicle 12, method 100 proceeds to step 130, where the various data is recorded from the components associated with the path vehicle 12 as described in FIG. 2. More specifically, in one embodiment, the following information is recorded continuously; (i) the left and right wheel positional information as determined by the positional encoders, (ii) a compass reading, (iii) the speed of the vehicle, (iv) the thermopile readings, and (v) the time. The left and right wheel positions are used to retrace the path that the vehicle has taken. The compass readings are used to provide the directional data for when the vehicle is operating in an autonomous mode. The speed is determined through the determination of the wheel positions as a function of time. The thermopile readings are used to detect the temperature sources that are placed at the outer extremities. The temperature sources may emit different temperature intensities, and the thermopile is programmed to detect differences in temperature rater than a specific temperature that may be associated with a specific temperature source. Step 130 is used to continuously record the data when the vehicle is operating. When the user/operator has operated the vehicle in the entire task space 10, method 120 proceeds to step 132, where method 120 terminates. At the conclusion of method 120 the path vehicle 12 will have traversed the task space once, where it will have stored the respective coordinate data that will allow it to undertake an autonomous traversal of the task space, thereby allowing it to autonomously operate and perform its functions.

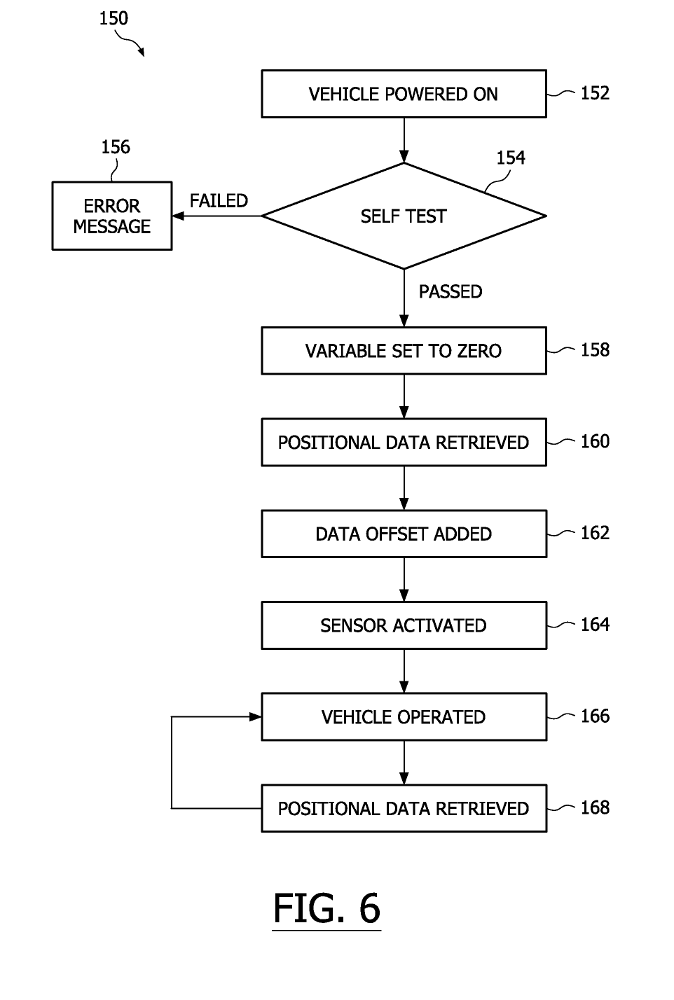

Reference is now made to FIG. 6, where a flowchart illustrating the steps in an exemplary embodiment of the autonomous mode in method 150 is shown. In the autonomous mode of operation as shown in method 150, the thermopiles are placed in generally the sample locations as they were placed during the operation of the vehicle while in the teaching mode. In the autonomous mode as is described in further detail below, the method is able to use the positional data as specified in the teaching method so that the vehicle under its own control is able to navigate from the starting point 14 to the end point 16. Method 150 begins at step 152, where the vehicle is powered on and placed at the starting point of the task space 10. Once placed at the starting point 14, the user or operator will initiate the autonomous mode by engaging a start mechanism associated with the device. The start mechanism may include, but is not limited to a start button, or a command generated via remote control. Method 150 then proceeds to step 154. At step 154, a self diagnostic test is performed to determine whether the components associated with the path vehicle 12 are operational, and whether the previous positional data that was determined from the teaching mode can be retrieved. If it is determined at step 154 that the diagnostic test was not successful, method 150 proceeds to step 156. At step 156, method 150 terminates with an error message. If the check performed at step 154 is successful, method 150 proceeds to step 158. At step 158, the variables associated the path correction are set to zero. The path correction parameters are used to determine the boundaries associated with the task space and the direction of travel associated with the path vehicle. Therefore, the offsets associated with the compass and the thermopiles are set to zero. Because during the teach mode, the positional co-ordinates associated with the path tracing vehicle as a function of time were stored, that information is used in the autonomous mode to ensure that the path vehicle is able to correct itself if the vehicle requires. The determination as to whether path correction is required is made based on a comparison of information that is recorded during the teaching mode and information that is recorded during the autonomous mode. Where one or more of the compass direction, wheel speed, number of revolutions, wheel position information or thermopile readings do not match the previously recorded information during the teach mode, the determination that a correction is required is made. Method 150 then proceeds to step 160 where the positional data is then retrieved, and the path correction offsets are added to the positional data that is retrieved. The positional data as a function of time includes data regarding the wheel positions, the compass readings, the thermopile data, and readings from the sensor that are used to detect obstructions. Method 150 then proceeds to step 162, where the data offsets are added to the positional data. In one embodiment, the software Method 150 then proceeds to step 164, where before the path vehicle begins to traverse the path 10 the sensor is activated to determine whether any obstacles are found in the path of the path vehicle, such that the path vehicle is unable to progress further. Where obstacles are detected upon the path, the co-ordinates of the obstacle are determined through the respective detection sensors, then the path vehicle determines an appropriate path of navigation around the obstacles based on the co-ordinates of the outer extremities of the obstacle as determined by the respective sensors. The co-ordinate positions to allows for navigation around the obstacle are retrieved from memory and the path vehicle is set on a path to navigate around the obstacle. If the determination made at step 164 indicates that obstacles are not present, method 150 proceeds to step 166, where the path vehicle is operated within the path. During the operation of the vehicle 12, the positional data is continuously retrieved in step 168. During the operation of the vehicle 12 in the autonomous mode, the retrieval of the positional data is undertaken continuously, and a check is performed to determine whether the positional recordings at a certain instant of time, match those that were recorded during the corresponding instant of time from the teaching mode. Where the positional data that is retrieved indicates the data does not in fact match the data of the teaching mode, the appropriate path correction data is applied, and such corrected data is used to operate the path vehicle 12. Method 160 continues until the path vehicle has traversed the entire path, where upon the method terminates.

In alternative embodiments, the path vehicle also operates in what is referred to as a directed mode. When embarking on the traversal of a task space 10, the path vehicle 12, may be directed to follow a predetermined route. Where the path vehicle follows a predetermined route, the path vehicle 12 may navigate a task space 10 based on coordinates that are provided through the interface 40 of the path vehicle 12. The interface 40 will allow for users to first determine a coordinate set that represents an area that should be traversed and for that set to then be uploaded through the interface 40. In such alternative embodiments, the coordinate set may allow the path vehicle 12 to be used to traverse paths while carrying out specific functions. For example, the path tracing vehicle 12 may be used in a landscape to paint specific signs on the terrain, or to mow grass in a manner so as to leave certain insignias. The functions associated with the tracing vehicle 12 may vary as will be understood by one of skill in the art.

While various embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

1. A method for determining a path for the autonomous operation a vehicle with a task space, the method comprising:
detecting multiple temperature sources located at the boundaries of the task space;
recording the one or more positional coordinates associated with the temperature sources;
storing the one or more positional coordinates; and
retrieving the one or more positional coordinates and navigating the vehicle based on the one or more positional coordinates.

2. The method of claim 1, wherein the positional coordinates include one or more readings of the (i) left and right wheel positions (ii) a compass reading, (iii) the speed of the vehicle, (iv) a thermopile readings, and (v) a time reading.

3. The method of claim 1, wherein the vehicle carries out a function within the task space.

4. The method of claim 3, wherein the function is selected from one of: vacuuming, shoveling, lawn mowing, dusting.

5. A method for operating a vehicle within a task space autonomously, the method comprising;
operating the vehicle in a teaching mode in the task space and recording or more positional coordinates during the operation and detecting one or more temperature sources located at the boundaries of the task space and recording one or more positional coordinates associated with the location of the detected one or more temperature sources;
operating the vehicle in an autonomous mode by recalling the one or more positional coordinates recorded during the teach mode.

6. The method of claim 5, wherein the positional coordinates include one or more readings of the (i) left and right wheel positions (ii) a compass reading, (iii) the speed of the vehicle, (iv) a thermopile readings, and (v) a time reading.

7. The method of claim 5, wherein the vehicle carries out a function within the task space.

8. The method of claim 7, wherein the function is selected from one of: vacuuming, shoveling, lawn mowing, dusting.

9. A path tracing vehicle for autonomous operation within a task space, the vehicle comprising a memory for storing one or more sets of positional coordinates, and a processor coupled to the memory and for:
(i) detecting multiple temperature sources located at the boundaries of the task space;
(ii) recording the one or more positional coordinates associated with the temperature sources;
(iii) storing the one or more positional coordinates; and
(iv) retrieving the one or more positional coordinates and navigating the vehicle based on the one or more positional coordinates.

10. The path tracing vehicle of claim 9, wherein the positional coordinates include one or more readings of the (i) left and right wheel positions (ii) a compass reading, (iii) the speed of the vehicle, (iv) a thermopile readings, and (v) a time reading.

11. The path tracing vehicle of claim 9, wherein the vehicle carries out a function within the task space.

12. The path tracing vehicle of claim 10, wherein the function is selected from one of: vacuuming, shoveling, lawn mowing, dusting.
